(19) United States
(12) Patent Application Publication
(10) Pub. No.: US 2025/0108831 A1
(43) Pub. Date: Apr. 3, 2025

(54) METHOD FOR OPERATING AN AUTONOMOUS VEHICLE

(71) Applicant: Torc Robotics, Inc., Blacksburg, VA (US)

(72) Inventor: Fridtjof Stein, Ostfildern (DE)

(21) Appl. No.: 18/899,434

(22) Filed: Sep. 27, 2024

(30) Foreign Application Priority Data
Sep. 29, 2023 (DE) 102023126733.7

(51) Int. Cl. B60W 60/00

(52) U.S. Cl. CPC B60W 60/001; B60W 2552/10; B60W 2554/402; B60W 2554/4041; B60W 2554/4046; B60W 2754/30

(57) ABSTRACT

A method for operating an autonomous vehicle includes detecting an environment of the autonomous vehicle using a sensor system positioned in at least in one direction of travel in front of the autonomous vehicle, wherein data of the environment is made available to a computing unit, wherein a trajectory of a vehicle driving ahead driving back and forth over a plurality of lanes of a multi-lane roadway is tracked by the sensor system and/or the computing unit. The method includes recognizing that the vehicle in front is an emergency vehicle and identifying when a movement pattern in the trajectory is detected which persists over a period of more than 20 seconds where the emergency vehicle drives back and forth over a plurality of lanes. The driving behavior of the autonomous vehicle is adapted to drive at a distance behind the emergency vehicle and stop when the emergency vehicle stops.

### CROSS REFERENCE TO RELATED APPLICATIONS

The present application claims priority to German Patent Application No. 102023126733.7, filed on Sep. 29, 2023, and titled “Method for operating an ego vehicle”, the disclosure of which is hereby incorporated by reference in its entirety.

### TECHNICAL FIELD

The present disclosure relates to a method for operating an autonomous vehicle, and particularly, a method for adapting the driving behavior of an autonomous vehicle based on a vehicle driving ahead.

### BACKGROUND

In road traffic, there may be vehicles that drive unsafely or do not adhere to traffic regulations, and which in particular may change lanes repeatedly, especially on a multi-lane road. In some countries, for example in the USA, it is common for drivers of emergency vehicles, such as police vehicles, to allow their vehicle to drive back and forth between lanes across the entire width of the roadway to block multi-lane roads. Human road users are familiar with this procedure and interpret it accordingly.

US 2022/355802 A1 describes systems and methods for determining whether a vehicle is driving unsafely or unsatisfactorily. In some implementations, a system may determine one or more driving ratings for a vehicle based on observations of a driving behavior of the vehicle during a time period. The system may generate an indication of unsatisfactory driving based on at least one of the one or more driving ratings exceeding a threshold value. The system may notify one or more entities of unsatisfactory driving. In some aspects, the system can identify one or more hazardous driving characteristics exhibited by the vehicle during the time period based on the observations received from the one or more units. The system may also generate the unsatisfactory driving indication based, at least in part, on the identified hazardous driving characteristics.

The object of the present disclosure is to provide a novel method for operating an autonomous vehicle.

### BRIEF DESCRIPTION

In one aspect, a method for operating an autonomous vehicle, wherein the method includes detecting an environment of the autonomous vehicle, including a vehicle driving ahead, using a sensor system positioned in at least in one direction of travel in front of the autonomous vehicle, wherein data of the environment is made available to a computing unit, wherein a trajectory of the vehicle driving ahead driving back and forth over a plurality of lanes of a multi-lane roadway is tracked by the sensor system and/or the computing unit. The method includes recognizing that the vehicle in front is an emergency vehicle based on an active special light signal and/or an active special acoustic signal. The method includes identifying when a movement pattern in the trajectory is detected which persists over a period of more than 20 seconds and in which the emergency vehicle drives back and forth over a plurality of lanes. The method includes adapting the driving behavior of the autonomous vehicle such that the autonomous vehicle drives at a distance behind the emergency vehicle and stops when the emergency vehicle stops.

With the solution according to the present disclosure, complex, non-compliant behavior of other road users is correctly interpreted by an autonomous vehicle. As a result, accidents and other dangerous situations can be avoided. Furthermore, compliance with legal regulations is achieved by the autonomous vehicle. Police officers are authorized to enforce traffic laws, which an autonomous vehicle must also comply with. Otherwise, the operator of the autonomous vehicle must expect legal consequences such as fines or fleet immobilization.

The present disclosure can be used, for example, in an autonomous commercial vehicle, an autonomous bus or an autonomous passenger car.

### BRIEF DESCRIPTION OF DRAWINGS

Exemplary embodiments of the present disclosure are explained in more detail below with reference to drawings.

In particular:

FIG. 1 shows a schematic view of a roadway with a plurality of lanes, an autonomous vehicle and an emergency vehicle driving ahead,

FIG. 2 shows a schematic view of the autonomous vehicle and the emergency vehicle, and

FIG. 3 shows a schematic view of an exemplary processing chain of the autonomous vehicle.

Corresponding parts are provided with the same reference numerals in all figures.

### DETAILED DESCRIPTION

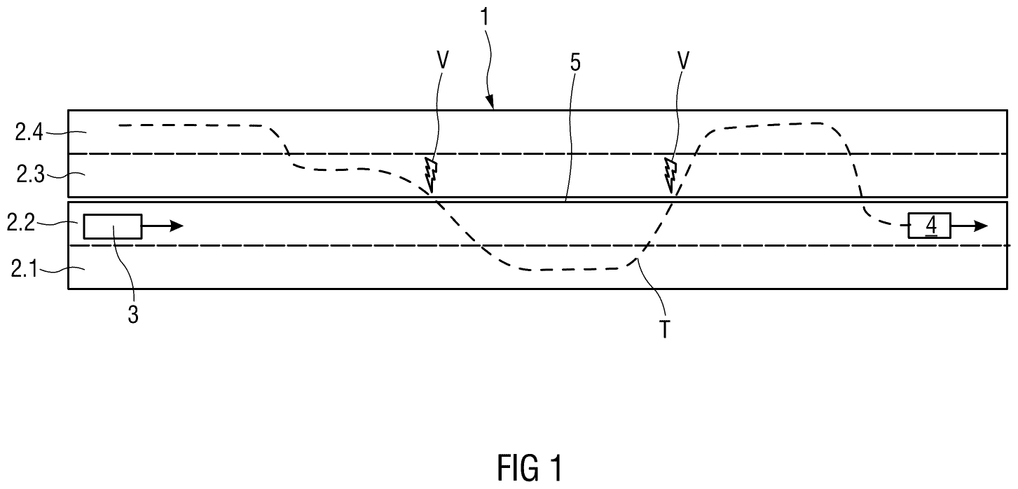

FIG. 1 is a schematic view of a roadway 1 with multiple lanes 2.1, 2.2, 2.3, 2.4. An autonomous vehicle 3 drives in one of the lanes 2.1, 2.2, 2.3, 2.4, for example lane 2.2. A preceding vehicle 4, for example an emergency vehicle 4, in particular a police vehicle, drives in front of the autonomous vehicle 3 and drives back and forth along a trajectory T over a longer period of time across all lanes 2.1, 2.2, 2.3, 2.4, wherein it commits violations V of the traffic regulations when driving over a solid lane marking 5 between lanes 2.2, 2.3. In some countries, for example in the USA, this movement pattern means that the driver of the emergency vehicle 4 requests the following vehicles not to overtake the emergency vehicle 4, but to follow slowly or even to stop. This movement pattern therefore contains a semantic signal that is understood by a human driver familiar with the semantic signal.

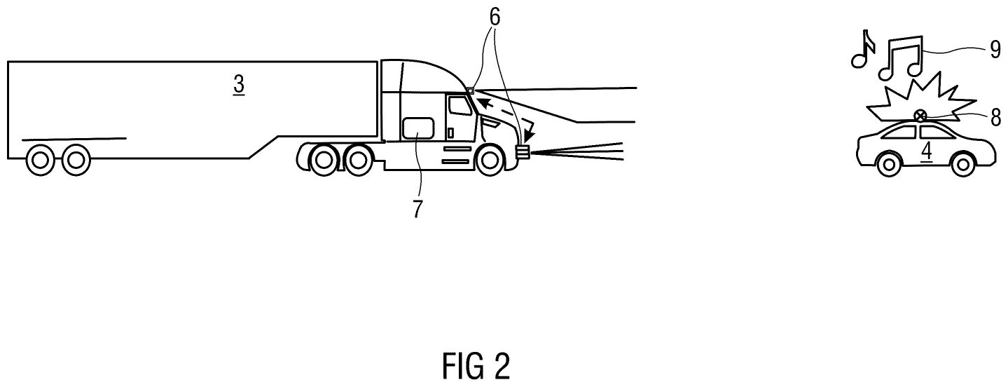

FIG. 2 is a schematic view of the autonomous vehicle 3, for example a commercial vehicle and the emergency vehicle 4. The autonomous vehicle 3 has a sensor system 6 for detecting an environment of the autonomous vehicle 3, in particular in front of the autonomous vehicle 3 in the direction of travel. The sensor system 6 can, for example, have at least one camera and/or at least one radar sensor and/or at least one LIDAR sensor. The sensor system 6 is coupled to a computing unit 7, which is configured to detect and track objects in the environment detected by the sensor system 6. Furthermore, the sensor system 6 can have at least one microphone for detecting sounds from the environment.

The emergency vehicle 4 can be recognized as an emergency vehicle 4 by its external design, for example its paintwork and/or foiling, and/or by an activated special light signal 8, for example blue light, and/or by an activated special acoustic signal 9, for example a siren.

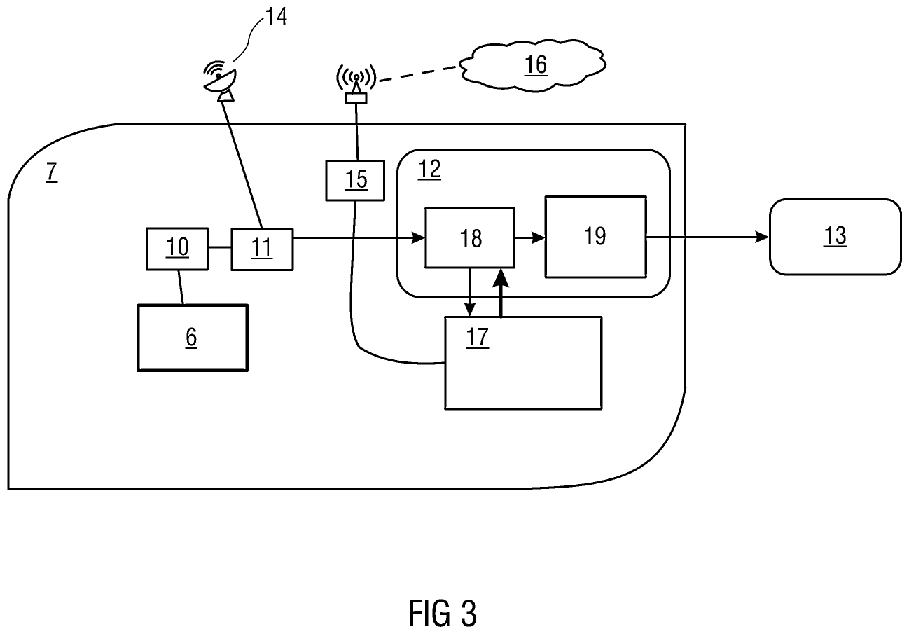

The computing unit 7 of the autonomous vehicle 3 can have a recognition module 17 shown in FIG. 3, which is configured to recognize the emergency vehicle 4 on the basis of these features.

The recognition module 17 can also be configured to detect and track the trajectory T of a vehicle 4 driving ahead, in particular over a longer period of time of more than about 20 seconds, for example, and to recognize the semantic signal, in particular if the vehicle 4 driving ahead has been recognized as an emergency vehicle 4 on the basis of the external design and/or by a special light signal 8 being switched on and/or by a special acoustic signal 9 being switched on.

A virtual driver of the autonomous vehicle 3, for example a behavior planning module 12 shown in FIG. 3, can be configured to adapt the driving behavior of the autonomous vehicle 3 according to the detected semantic signal, for example to drive at a distance behind the emergency vehicle 4 and to stop when the emergency vehicle 4 stops.

If the recognition module 17 has not recognized the vehicle 4 driving ahead as an emergency vehicle 4 based on the external design and/or the absence of a special light signal 8 and/or the absence of a special acoustic signal 9 and/or if the trajectory T with violations V of the traffic regulations lasts for less than the specified period, for example about 20 seconds or less, then a reckless or drunk driver in the vehicle 4 driving ahead can be inferred. In this case, the driving behavior of the autonomous vehicle 3 can also be adapted accordingly, for example, it can drive at a distance behind the vehicle 4 driving ahead. Furthermore, a message about the detected reckless or drunk driver can be sent to a backend 16 shown in FIG. 3.

FIG. 3 is a schematic view of an exemplary processing chain of the autonomous vehicle 3. Environmental data is detected by the sensor system 6 and fed to the computing unit 7. In the computing unit 7, the data from the sensor system 6 is fused in a fusion unit 10 and compared with an internal digital map 11 and localized. The fused data from the fusion unit 10 is fed to a behavior planning module 12. The behavior planning module 12 is configured to control actuators 13 of the autonomous vehicle 3 for steering, accelerator and brake.

The digital map 11 can be connected to a satellite navigation system 14.

The behavior planning module 12 has a situation analysis module 18 and a trajectory generator 19.

The computing unit 7 also has a recognition module 17, which is coupled with the situation analysis module 18 for data exchange.

The recognition module 17 can also communicate with a backend 16 via an interface 15, in particular wirelessly.

1. A method for operating an autonomous vehicle, the method comprising:
detecting an environment of the autonomous vehicle, including a vehicle driving ahead, using a sensor system positioned in at least in one direction of travel in front of the autonomous vehicle, wherein data of the environment is made available to a computing unit, wherein a trajectory of the vehicle driving ahead driving back and forth over a plurality of lanes of a multi-lane roadway is tracked by the sensor system and/or the computing unit, recognizing that the vehicle in front is an emergency vehicle based on an active special light signal and/or an active special acoustic signal;
identifying when a movement pattern in the trajectory is detected which persists over a period of more than 20 seconds and in which the emergency vehicle drives back and forth over a plurality of lanes; and
adapting the driving behavior of the autonomous vehicle such that the autonomous vehicle drives at a distance behind the emergency vehicle and stops when the emergency vehicle stops.

2. The method according to claim 1,
wherein the vehicle driving ahead is recognized as an emergency vehicle also by its external design.

3. The method according to claim 1,
wherein if the vehicle driving ahead is not recognized as an emergency vehicle by the absence of a special light signal and/or by the absence of a special acoustic signal and/or if the trajectory with violations of the traffic regulations lasts 20 seconds or less, a reckless or drunken driver in the vehicle driving ahead is inferred and the driving behavior of the autonomous vehicle is adapted so that it drives at a distance behind the vehicle driving ahead, wherein a message about the detected reckless or drunk driver is also being sent to a backend.

4. The method according to claim 2, wherein if the vehicle driving ahead is not recognized as an emergency vehicle based on the external design and/or by the absence of a special light signal and/or by the absence of a special acoustic signal and/or if the trajectory with violations of the traffic regulations lasts 20 seconds or less, a reckless or drunken driver in the vehicle driving ahead is inferred and the driving behavior of the autonomous vehicle is adapted so that it drives at a distance behind the vehicle driving ahead, wherein a message about the detected reckless or drunk driver is also being sent to a backend.
